(19) United States
(12) Patent Application Publication
(10) Pub. No.: US 2026/0357026 A1
(43) Pub. Date: Nov. 12, 2026

(54) FOAMABLE BRANCHED POLYPROPYLENE COMPOSITIONS AND FOAMED PRODUCTS THEREFROM

(71) Applicant: EXXONMOBIL CHEMICAL PATENTS INC., Baytown, TX (US)

(72) Inventors: Maksim E. SHIVOKHIN, Houston, TX (US); George J. PEHLERT, Houston, TX (US)

(73) Assignee: EXXONMOBIL CHEMICAL PATENTS INC., Baytown, TX (US)

(21) Appl. No.: 19/115,195

(22) PCT Filed: Jul. 27, 2023
(86) PCT No.: PCT/US2023/028869

§ 371 Date: Mar. 25, 2025

Related U.S. Application Data
(60) Provisional application No. 63/377,635, filed on Sep. 29, 2022.

(51) Int. Cl. C08J 9/12; C08J 9/14

(52) U.S. Cl. CPC C08J 9/122; C08J 9/141; C08J 2201/03; C08J 2203/06; C08J 2203/14; C08J 2323/12

(57) ABSTRACT

Foamable compositions may comprise a branched polypropylene having a g′ᵥᵢₛ value of about 0.5 to about 0.95, and a foaming agent blended with the branched polypropylene. The foamable compositions may be free of a phenolic stabilizer, such as Vitamin E or a Vitamin E derivative, but may optionally comprise a non-phenolic stabilizer. The foamable compositions may be free of stabilizer in some instances. The branched polypropylenes may be formed by irradiation of a substantially linear polypropylene with ionizing radiation, either in an absence of stabilizer or a non-phenolic stabilizer.

### FIELD

The present disclosure relates to polymeric foams and, more particularly, foamable compositions comprising branched polypropylenes and foamed articles produced therefrom.

### BACKGROUND

Polymeric foams may be produced by introducing a physical or chemical foaming agent into a molten polymer stream, blending the foaming agent with the polymer, and extruding the resulting mixture in a lower pressure environment while shaping into a desired product form. Exposure of the molten extradate to the lower pressure environment causes the foaming agent to gasify (either through a chemical reaction or through simple expansion upon undergoing depressurization), thereby forming cells in the polymer to define a polymeric foam. Depending on conditions, the cells may be open or closed in form. Foamable polymers and polymeric foams produced therefrom find use in a variety of industries including construction, automotive, and packaging, for example, as a consequence of their excellent mechanical properties, including high compressive strength.

Polyurethanes, polystyrenes, polyesters, and polyethylenes are among the polymers that have traditionally been utilized in polymeric foams. Polypropylene is a relatively new entry into the polymeric foam arena. Among the properties of polypropylene making such polymers desirable for incorporation in foams include, for example, excellent heat resistance, chemical resistance, and impact resistance, as well as thermal and electrical insulation properties. Impact resistance, for example, may make foamed polypropylenes especially desirable for use in automobile manufacturing.

Linear polypropylenes have limited melt strength and relatively low melting temperatures, which may make cell walls produced during foaming susceptible to rupture during continued cell growth, thereby leading to ineffective foam production. Blends of linear polypropylenes with other polymers having a higher melt strength may improve the cellular structure and foaming performance. Chemical alterations of linear polypropylenes may also be conducted to enhance the melt strength and foaming performance. For example, by introducing long-chain branching to linear polypropylenes, either during polymerization or via a post-polymerization synthetic modification, the melt strength and foaming performance of the resulting branched polypropylenes may be improved compared to the corresponding linear polypropylene counterparts.

Linear polypropylenes may be converted into branched polypropylenes through post-polymerization modifications, such as through radical-mediated processes. Suitable radical-mediated processes may include reactive extrusion with a peroxide-based free radical initiator or via irradiation with ionizing radiation, such as with an electron beam, x-rays, beta radiation, or gamma radiation. Such radical-mediated processes may be conducted in the presence of a stabilizer to protect the polypropylene from undergoing degradation instead of branching. Suitable stabilizers may include phenolic antioxidants. Use of Vitamin E as a natural phenolic stabilizer for polypropylene, for example, is described in U.S. Patent Application Publication 2020/0181349. Unfortunately, Vitamin E and other phenolic stabilizers may lessen the extent of functionalization that takes place through the radical-mediated process, thereby impacting the improvement in foaming performance that results from introducing branching to a parent linear polypropylene. Although the decreased extent of functionalization can be compensated for to some degree by increasing the amount of free radical initiator or using longer irradiation times, these approaches may increase production costs. Unfortunately, these stabilization approaches may also increase the risk of the polypropylene developing unwanted physical properties, such as brittleness or discoloration, for example. In addition, Vitamin E and other phenolic stabilizers may promote an undesirable increase in melt flow rates when converting a substantially linear polypropylene into a branched polypropylene.

### SUMMARY

In some aspects, the present disclosure provides foamable compositions comprising: a branched polypropylene having a g′ᵥᵢₛ value of about 0.5 to about 0.95, and a foaming agent blended with the branched polypropylene. The foamable composition may be free of a phenolic stabilizer according to various aspects. Foamed products may comprise the foamable compositions converted to a foamed form.

In some or other aspects, foaming processes may comprise: introducing a foaming agent into a branched polypropylene having a g′ᵥᵢₛ value of about 0.5 to about 0.95 to form a foamable composition, in which the foamable composition is free of a phenolic stabilizer; and inducing foam formation within the foamable composition to produce a foamed product comprising a foamed form of the foamable composition.

These and other features and attributes of the disclosed foamable compositions and foaming processes of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings. The following figures are included to illustrate certain aspects of the disclosure, and should not be viewed as exclusive configurations. The subject matter disclosed is capable of considerable modifications, alterations, combinations, and equivalents in form and function, as will occur to those skilled in the art and having the benefit of this disclosure.

FIG. 1 is a graph of the small amplitude oscillatory shear (SAOS) data for the branched polypropylene of Entry 5 fit to the Winter-Chambon model.

FIG. 2 is a plot of expansion ratio as a function of temperature for branched polypropylenes in comparison to various commercial polypropylenes. The data in FIG. 2 was obtained under batch foaming conditions.

FIG. 3 is a plot of average cell diameter as a function of temperature for foamed polypropylenes in comparison to various commercial polypropylenes. The data in FIG. 3 was obtained under batch foaming conditions.

FIG. 4 is a plot of foam density as a function of temperature for foamed polypropylenes in comparison to various commercial polypropylenes. The data in FIG. 4 was obtained under extrusion foaming conditions.

FIG. 5 is a plot of die pressure as a function of melt temperature during extrusion foaming.

FIG. 6 is a plot of cell density as a function of temperature for foamed polypropylenes in comparison to various commercial polypropylenes. The data in FIG. 6 was obtained under batch foaming conditions.

### DETAILED DESCRIPTION

The present disclosure relates to polymeric foams and, more particularly, foamable compositions comprising branched polypropylenes and foamed articles produced therefrom.

As discussed above, polymeric foams containing branched polypropylenes may be utilized in a number of industries due the high melt strength and other desirable properties of these types of polymers. Branching is often introduced to a substantially linear polypropylene following reactor production thereof, such as through a radical-mediated process. The radical-mediated processes may utilize a peroxide-based free radical initiator or be conducted by irradiation with ionizing radiation, for example.

Stabilizers such as Vitamin E and similar phenolic stabilizers are commonly used to promote polymer stability during radical-mediated branching processes, such as to improve storage life of the resulting branched polypropylenes. Unfortunately, such stabilizers may decrease the effectiveness of the radical-mediated branching, thereby lowering the extent of branching that is obtained. The decreased extent of branching may lead to an unacceptably low melt strength for foaming. Moreover, Vitamin E and other phenolic stabilizers may undesirably increase melt flow rate values as well. Other undesirable properties, such as polymer yellowing, may occur in some instances.

The present disclosure provides foamable compositions and foamed products formed therefrom in which extensive long-chain branching is introduced through post-polymerization modifications of a substantially linear polypropylene in the absence of phenolic stabilizers, such as Vitamin E or Vitamin E-derived stabilizers. Surprisingly, branched polypropylenes lacking such phenolic stabilizers may maintain adequate stability when produced by irradiation with ionizing radiation, such as electron beam irradiation, thereby affording improved melt strength values while still maintaining desirably low melt flow rates. The foregoing approach allows for economical production of foamable compositions containing branched polypropylenes for batch-, extrusion-, blow molding-, and injection molding-based fabrication processes.

Should it be determined that a stabilizer is needed to promote stability of the branched polypropylenes or foamable compositions while introducing branching or during long-term storage, a suitable stabilizer may be introduced, provided that the stabilizer is not a phenolic stabilizer, such as Vitamin E or a Vitamin E derivative. If used, the non-phenolic stabilizer may be introduced during the post-polymerization process in which the branches are introduced to the substantially linear polypropylene. Alternately, a suitable non-phenolic stabilizer may be introduced to the branched polypropylene after branches have been introduced thereto through a post-polymerization modification. The non-phenolic stabilizer may promote stability of the branched polypropylene during storage until a foamable composition has been produced therefrom. In addition, the non-phenolic stabilizer may remain in the foamable compositions and foamed products resulting therefrom to afford long-term stability. Suitable non-phenolic stabilizers are discussed in more detail below.

As still another alternative, a substantially linear polypropylene may be converted to a branched polypropylene in the absence of stabilizer or in the presence of a non-phenolic stabilizer, and a phenolic stabilizer, such as Vitamin E or a Vitamin E derivative, may be blended with the branched polypropylene after the post-polymerization modification is complete. Branched polypropylenes and foamable compositions formulated in this manner may avoid the undesirable effects that may occur when introducing branches in the presence of a phenolic stabilizer, while still realizing the long-term stabilization benefits afforded by phenolic stabilizers, such as Vitamin E and Vitamin E derivatives. For example, adding a phenolic stabilizer after introducing branches to a substantially linear polypropylene may avoid the undesirable increases in melt flow rates and the decreased extent of branching that may otherwise occur.

Further advantages of omitting phenolic stabilizers at least while introducing branching to substantially linear polypropylenes may include the ability to form polymeric foams having higher cell counts and, by extension, a smaller cell size. These features may afford foamable compositions comprising branched polypropylenes that exhibit high expansion ratios over a broad range of temperatures.

### DEFINITIONS

All numerical values within the detailed description and the claims herein are modified by “about” or “approximately” with respect to the indicated value, and take into account experimental error and variations that would be expected by a person having ordinary skill in the art. Unless otherwise indicated, room temperature is about 23 °C.

As used in the present disclosure and claims, the singular forms “a,” “an,” and “the” include plural forms unless the context clearly dictates otherwise. The term “and/or” as used in a phrase such as “A and/or B” herein is intended to include “A and B,” “A or B,” “A,” and “B.”

For the purposes of the present disclosure, the new numbering scheme for groups of the Periodic Table is used. In said numbering scheme, the groups (columns) are numbered sequentially from left to right from 1 through 18, excluding the f-block elements (lanthanides and actinides). Under this scheme, the term “transition metal” refers to any atom from Groups 3-12 of the Periodic Table, inclusive of the lanthanides and actinide elements.

As used herein, Mn is number average molecular weight, Mw is weight average molecular weight, and Mz is z average molecular weight, wt % is weight percent, and mol % is mole percent. Molecular weight distribution (MWD), also referred to as polydispersity index (PDI), is defined to be Mw divided by Mn. Unless otherwise noted, all molecular weight units (e.g., Mw, Mn, and Mz) are in units of g/mol (g·mol⁻¹). Procedures for determining polymer molecular weights thereof are specified below.

For the purposes of the present disclosure, and unless otherwise specified, an “olefin,” alternatively referred to as “alkene,” is a linear, branched, or cyclic compound of carbon and hydrogen having at least one double bond. For purposes of this disclosure, when a polymer or copolymer is referred to as comprising an olefin, the olefin present in such polymer or copolymer is the polymerized form of the olefin. For example, when a copolymer is said to have a “propylene” content of 35 wt % to 55 wt %, it is understood that the mer unit in the copolymer is derived from propylene in the polymerization reaction and said derived units are present at 35 wt % to 55 wt %, based upon the weight of the copolymer. A “polymer” has two or more of the same or different mer units. A “homopolymer” is a polymer having mer units that are the same. A “copolymer” is a polymer having two or more mer units that are different from each other. A “terpolymer” is a polymer having three mer units that are different from each other. Accordingly, the definition of copolymer, as used herein, includes terpolymers. “Different” as used to refer to mer units indicates that the mer units differ from each other by at least one atom or are different isomerically. A “propylene polymer” or “propylene copolymer” is a polymer or copolymer comprising at least 50 mol % propylene-derived units, and so on.

A “straight-chain polypropylene” or “linear polypropylene” comprises a polymer backbone resulting from polymerization of propylene and optionally one or more additional ethylenically unsaturated monomers, and at least methyl group branches extending from the polymer backbone, wherein the methyl group branches originate from the propylene. A “branched polypropylene” contains further branches in addition to the methyl group branches. A “substantially linear polypropylene” contains no more than about 2 long-chain branches per 100 main chain carbon atoms, preferably no more than about 1 long-chain branch per 100 carbon atoms, and more preferably no more than about 1 long-chain branch per 200 carbon atoms.

For the purposes of the present disclosure, and unless otherwise specified, the term “Cn” refers to hydrocarbon(s) having n carbon atom(s) per molecule, wherein n is a positive integer. The term “hydrocarbon” refers to a class of compounds containing hydrogen bound to carbon, and encompasses (i) saturated hydrocarbon compounds, (ii) unsaturated hydrocarbon compounds, and (iii) mixtures of hydrocarbon compounds (saturated and/or unsaturated), including mixtures of hydrocarbon compounds having different values of n. Likewise, a “Cₘ-C_{y}” group or compound refers to a group or compound comprising carbon atoms at a total number thereof in the range from m to y. Thus, a C₁-C₅₀ alkyl group refers to an alkyl group comprising carbon atoms at a total number thereof in the range from 1 to 50.

For the purposes of the present disclosure, and unless otherwise specified, the terms “group,” “radical,” and “substituent” may be used interchangeably.

For the purposes of the present disclosure, and unless otherwise specified, the terms “hydrocarbyl radical,” “hydrocarbyl group,” or “hydrocarbyl” may be used interchangeably and are defined to mean a group consisting of hydrogen and carbon atoms only. Suitable hydrocarbyls are C₁-C₁₀₀ radicals that may be linear, branched, or cyclic, and when cyclic, aromatic or non-aromatic. Examples of such radicals include, but are not limited to, alkyl groups such as methyl, ethyl, n-propyl, isopropyl, n-butyl, isobutyl, sec-butyl, tert-butyl, pentyl, iso-amyl, hexyl, octyl, cyclopropyl, cyclobutyl, cyclopentyl, cyclohexyl, cyclooctyl, and aryl or aryl-containing groups, such as phenyl, benzyl, naphthyl.

For the purposes of the present disclosure, and unless otherwise specified, the terms “alkyl radical” and “alkyl” are used interchangeably throughout this disclosure. For purposes of the present disclosure, “alkyl radical” is defined to be C₁-C₁₀₀ alkyls that may be linear, branched, or cyclic. Examples of such radicals can include methyl, ethyl, n-propyl, isopropyl, n-butyl, isobutyl, sec-butyl, tert-butyl, pentyl, iso-amyl, hexyl, octyl, cyclopropyl, cyclobutyl, cyclopentyl, cyclohexyl, cyclooctyl, and the like including their substituted analogues.

The term “alpha-olefin” refers to an olefin having a terminal carbon-carbon double bond in the structure thereof ((R¹R²)—C═CH₂, where R¹ and R² can be independently hydrogen or any hydrocarbyl group; preferably R¹ is hydrogen and R² is an alkyl group). A “linear alpha-olefin” is an alpha-olefin defined in this paragraph, wherein R¹ is hydrogen, and R² is hydrogen or a linear alkyl group.

For the purposes of the present disclosure, and unless otherwise specified, ethylene shall be considered an α-olefin.

For the purposes of the present disclosure, and unless otherwise specified, a composition that is “foamable” means that foam formation has not yet taken place, but the composition is capable of forming a foam once exposed to suitable conditions. A “foamed composition” or “foamed product,” in contrast, means that foam formation has taken place to introduce a plurality of cells within a polymer of the composition.

As used herein, the term “irradiation” refers to a process involving bombardment of a substrate with ionizing radiation, such as beta radiation, gamma radiation, x-rays, electrons, or the like.

Unless otherwise specified, branching indices herein are specified as a g′ᵥᵢₛ value. A given g′ᵥᵢₛ value may be determined by GPC-4D, as discussed further herein.

### Linear Polypropylenes and Polymerization Processes

The present disclosure describes foamable compositions comprising a branched polypropylene and a foaming agent. The branched polypropylenes may be obtained from a substantially linear polypropylene, as described below. Suitable linear polypropylenes and methods for production thereof are not considered to be particularly limited.

Suitable linear polypropylenes that may be subsequently converted to branched polypropylenes may comprise a polymerized reaction product of propylene. The linear polypropylenes and the resulting branched polypropylenes formed therefrom may be polypropylene homopolymers, polypropylene copolymers, blends of a polypropylene and a second polymer, or any combination thereof. Suitable polypropylene copolymers may include, for example, a polypropylene random copolymer, a polypropylene block copolymer, a polypropylene impact copolymer, or any combination thereof. Suitable polypropylene random copolymers may comprise at least about 50 wt % propylene and one or more additional monomers, such as ethylene or a C₄-C₁₀ alpha-olefin. The one or more additional monomers (comonomers) may comprise about 1 wt %, or about 2 wt %, or about 4 wt %, or about 10 wt % to about 15 wt %, or about 20 wt %, or about 25 wt %, or about 30 wt %, or even up to 50 wt % of the polypropylene copolymer by mass. An impact copolymer is characterized as having an elastomeric phase dispersed within the polypropylene. The impact copolymer may comprise a polypropylene continuous phase and an elastomeric phase dispersed in the polypropylene continuous phase. The elastomeric phase may comprise an ethylene/propylene rubber, an ethylene/C₄-C₈ olefin rubber, or the like. The mass fraction of the elastomeric phase in the polypropylene continuous phase may range from about 10 wt %, or about 15 wt %, or about 20 wt %, or about 22 wt %, or about 24 wt % to about 26 wt %, or about 28 wt %, or about 30 wt %, or about 35 wt %, or about 40 wt %, or about 45 wt %.

Substantially linear polypropylenes suitable for being converted into branched polypropylenes may be produced in a solution or slurry process, which may employ two or more reactors in series wherein the level of chain-termination agent, such as hydrogen, is the same or within about 2%, or about 5%, or 10% of the same concentration value among the various reactors. Stated alternately, the MFR (ASTM D1238, Condition L, 230 °C/2.16 kg) of the substantially linear polypropylene from the first reactor is the same or within about 2%, or about 5%, or about 10% of the MFR value of the linear polypropylene obtained from the various reactors.

In any embodiment, the linear polypropylenes may have an isopentad percentage of greater than 85%, 90%, 92%, or 95%, as measured by ¹³C NMR (mmmm percentages). Polypropylene microstructure is determined by ¹³C-NMR spectroscopy, including the concentration of isotactic and syndiotactic diads ([m] and [r]), triads ([mm] and [r]), and pentads ([mmmm] and [rrrr]). The designation “m” or “r” describes the stereochemistry of pairs of contiguous propylene groups, “m” referring to meso and “r” to racemic. Also in any embodiment, the substantially linear polypropylenes may have a melt flow rate (MFR) within the range from 0.1, or 0.5, or 1, or 2 g/10 min to 12, or 16, or 20, or 40 g/10 min, as determined according to ASTM D1238 Condition L (230 °C/2.16 kg).

In any embodiment, the substantially linear polypropylenes may have a Mn of greater than about 20,000, or about 20,000 g/mol to about 90,000 g/mol, or about 30,000 g/mol to about 90,000 g/mol, or about 40,000 g/mol to about 80,000 g/mol. In any embodiment, the substantially linear polypropylenes may have a Mw of greater than about 150,000 g/mol, or about 150,000 g/mol to about 500,000 g/mol, or about 200,000 g/mol to about 400,000 g/mol. In any embodiment, the substantially linear polypropylenes may have a Mz of greater than about 700,000 g/mol, or about 700,000 g/mol to about 3,200,000 g/mol, or about 1,000,000 g/mol to about 3,000,000 g/mol. Mw, Mn, Mz can be determined via GPC-4D using a light scattering detector (LS), as described further herein. The resulting branched polypropylenes may have Mn, Mw, and Mz values within the same general ranges or higher.

In any embodiment, the substantially linear polypropylenes and resulting branched polypropylenes may have a molecular weight distribution (Mw/Mn) of about 20 or less, or about 10 or less, or about 8 or less, such as within a range of about 3 to about 10, or about 4 to about 9, or about 5 to about 7.5, or about 5, or about 6, or about 7, to about 8, or about 10, or about 12, or about 14, or about 16, or about 18, or about 20. Also in any embodiment, the substantially linear polypropylenes and resulting branched polypropylenes may have an Mz/Mw value of about 10 or less, or about 8 or less, or about 7 or less, or about 6 or less, such as about 2 to about 8, or about 3 to about 6, or about 2.5 to about 5.

In any embodiment, the substantially linear polypropylenes may have a melt strength of about 1 cN or greater, or about 5 cN or greater, or about 10 cN or greater, or about 15 cN or greater, or about 20 cN or greater, such as about 5 cN to about 25 cN, or about 10 cN to about 30 cN, or about 8 cN to about 20 cN, or about 15 cN to about 30 cN, as determined using a melt tensile testing device (e.g., Rheotens) at 190 °C, or within a range from about 1 cN, or about 5 cN, or about 10 cN, or about 15 cN, or about 20 cN to about 30 cN, or about 35 cN or about 40 cN.

In any embodiment, the substantially linear polypropylenes may have a viscosity ratio within a range from about 35 to about 80, as determined from the complex viscosity ratio at 0.01 to 100 rad/s angular frequency at a fixed strain within the linear deformation limit (e.g., a fixed strain of 10%) at 190 °C.

In any embodiment, the substantially linear polypropylenes may have a heat distortion temperature of greater than or equal to about 80 °C, as determined according to ASTM D648 using a load of 0.45 MPa. Finally, in any embodiment, the linear polypropylenes may have a Flexural Modulus (1% secant) within the range from about 900 MPa or about 1600 MPa or about 2000 MPa to about 2400 MPa or about 2500 MPa, as determined according to ASTM D790A.

The substantially linear polypropylenes can be present in any form suitable for undergoing a post-polymerization modification to introduce branching, such as in the form of reactor granules and/or flakes, or as extruder-formed pellets.

### Branched Polypropylenes, Post-Polymerization Modifications, Foamable Compositions, and Foamed Products

The substantially linear polypropylenes described above may be converted into branched polypropylenes suitable for producing foamable compositions. Foamable compositions of the present disclosure may comprise a branched polypropylene, and a foaming agent blended with the branched polypropylene, wherein the foamable composition is free of a phenolic stabilizer. Preferably, the foamable compositions are free of Vitamin E or a Vitamin E derivative. Optionally, the foamable compositions may be free of stabilizer altogether or alternately contain a non-phenolic stabilizer. The branched polypropylenes may have a g′ᵥᵢₛ value of about 0.5 to about 0.95, or about 0.6 to about 0.8, or about 0.7 to about 0.9, or about 0.55 to about 0.75, or about 0.6 to about 0.9, or about 0.75 to about 0.85, or about 0.8 to about 0.9, or about 0.85 to about 0.95.

Mw/Mn and Mz/Mw values for the branched polypropylenes may reside within the ranges disclosed above. In some embodiments, the branched polypropylenes may have Mw/Mn and/or Mz/Mw values that are higher than those of the substantially linear polypropylenes from which they are produced.

In any embodiment, the branched polypropylenes may have MFR values greater than about 0.1 dg/min, or greater than about 0.5 dg/min, such as about 0.1 dg/min to about 90 dg/min, or about 0.1 dg/min to about 40 dg/min, or about 1 dg/min to about 90 dg/min, or about 1 dg/min to about 40 dg/min, or about 1 dg/min to about 10 dg/min, or about 2 dg/min to about 8 dg/min or about 5 dg/min to about 10 dg/min, or about 8 dg/min to about 15 dg/min, as determined by ASTM1238-20 (2.16 kg at 230 °C).

In any embodiment, the branched polypropylenes may have melt strength values (190 °C) of about 25 cN or greater, or about 35 cN or greater, or about 40 cN or greater, and about 80 cN or below or about 90 cN or below, such as about 20 cN to about 80 cN, or about 30 cN to about 70 cN, or about 35 cN to about 65 cN, or about 50 cN to about 80 cN, or about 40 cN to about 60 cN.

In any embodiment, the branched polypropylenes may have a gel stiffness, S, of about 66 Pa·sⁿ or greater, or about 66 Pa·sⁿ to about 2300 Pa·sⁿ, or about 66 Pa·sⁿ to about 4300 Pa·sⁿ, wherein n is the critical network relaxation exponent. The critical network relaxation exponent, n, may range from about 0.05 to about 0.95, or about 0.1 to about 0.9, or about 0.1 to about 0.85, or about 0.2 to about 0.8, or about 0.5 to about 0.9, or about 0.5 to about 0.8. The gel stiffness, S, and critical network relaxation exponent, n, may be determined by fitting to a Winter-Chambon model, which will be familiar to persons having ordinary skill in the art.

In any embodiment, the branched polypropylenes may have a peak melting point, Tm, (also referred to as melting point) of about 130 °C to about 170 °C, or about 140 °C to about 170 °C, or about 150 °C to about 170 °C. The branched polypropylenes may have a peak crystallization temperature, Tc, (also referred to as crystallization temperature) of about 90 °C to about 130 °C, or about 100 °C to about 120 °C, or about 110 °C to about 130 °C, or about 100 °C to about 140 °C, or about 110 °C to about 120 °C Tm and Tc may be determined by differential scanning calorimetry.

Post-polymerization modifications may be conducted in the present disclosure in order to convert a substantially linear polypropylene into a branched polypropylene in the absence of a phenolic stabilizer. One such technique for inducing long-chain branching within a polypropylene is by exposing a substantially linear polypropylene to ionizing radiation in an irradiation process. In some examples, branching may be introduced by exposing a substantially linear polypropylene to electromagnetic radiation having a frequency greater than that of visible light, such as, for instance, near ultraviolet radiation, extreme ultraviolet radiation, soft x-rays, hard x-rays, gamma rays, and high-energy gamma rays. In other examples, branching may be introduced by electron beam radiation, also referred to as e-beam radiation, or beta radiation. In still other examples, a free radical initiator may be utilized to convert a substantially linear polypropylene into a branched polypropylene. Any of the foregoing may introduce branching into a substantially linear polypropylene in the disclosure herein. Preferably, branching is introduced to the substantially linear polypropylene by an irradiation process, such as an e-beam process. Illustrative description of e-beam processes follows.

E-beam radiation is a form of ionizing energy that is generally characterized by its low penetration and high dose rates. The electrons are generated by equipment referred to as accelerators, which are capable of producing beams that are either pulsed or continuous. The term “beam” is meant to include any area exposed to electrons, which may range from a focused point to a broader area, such as a line or field. The electrons are produced by a series of cathodes (electrically heated tungsten filaments) that generate a high concentration of electrons. These electrons are then accelerated across a potential. The accelerating potential is typically in the keV to MeV range (where eV denotes electron volts), depending on the depth of penetration required. The irradiation dose is usually measured in units of Gray (Gy) but also may be expressed in rad, where 1 Gy is equivalent to 100 rad, or, more typically, 10 kGy is equivalent to 1 Mrad. Commercial e-beam units generally produce energies from about 50 keV to greater than about 10 MeV (million electron volts). The dose of electrons delivered to a substantially linear polypropylene may determine the extent of branching that is obtained following irradiation.

When converting a substantially linear polypropylene into a branched polypropylene in the disclosure herein, electrons may be employed at a dose of about 100 kGy or less in multiple exposures. The source can be any electron beam unit operating in a range of about 50 keV to 10 MeV or even greater, with a power output capable of supplying the desired dosage. The electron voltage can be adjusted to appropriate levels for irradiating the substantially linear polypropylene such as within a range of about 100 keV to about 6000 keV, or about 300 keV to about 5000 keV, or about 500 keV to about 2500 keV, or about 1000 keV to about 3000 keV, or about 3000 keV to about 6000 keV. A wide range of apparatuses suitable for irradiating polymers and polymeric articles is available.

Effective dosing rates for forming branched polypropylenes by irradiation may range from about 10 kGy to about 100 kGy, or about 20 kGy to about 90 kGy, or about 30 kGy to about 80 kGy, or about 50 kGy to about 60 kGy. In a particular aspect, the irradiation may be carried out at room temperature.

Without wishing to be bound by theory, it is believed that two competing processes may occur upon irradiation of a substantially linear polypropylene to form a branched polypropylene. In portions of the polymer chains containing pendant methyl groups (such as those polymer units derived from propylene), the carbon atoms in the polymer backbone are susceptible to chain scission upon irradiation, which results in lowered molecular weight. The irradiation process also breaks the bonds between carbon and hydrogen atoms comprising the backbones of the polymer chains, creating free radicals that are available to crosslink with free radicals on adjacent polymer chains, thereby increasing the molecular weight. Thus, irradiation leads to increased branching, either through crosslinking which builds a polymer network, or through scission, which disrupts formation of a broad polymer network. To provide polymers with good tensile and elastic properties, it is desired to reduce chain scission while encouraging crosslinking and branching of adjacent polymer chains.

In polymers containing predominantly propylene, the dominant mechanism which takes place upon irradiation may be scissioning to create long-chain branching but with an increase in MFR values. In polyethylene polymers, on the other hand, the dominant mechanism may be crosslinking and branching without a significant increase in MFR. The inclusion of ethylene-derived units in substantially linear polypropylenes therefore may enhance branching and reduce chain scission in the resulting branched polypropylenes, thereby leading to improved long-chain branched topology. Polymer properties resulting from irradiation in the disclosure herein may therefore be regulated by altering the amount of polypropylene homopolymer to polypropylene co-polymer and/or the amount of ethylene-derived units in the polypropylene copolymer. Surprisingly, by omitting a phenolic stabilizer at least during irradiation, the amount of scissioning may be decreased and the amount of branching may increase to afford branched polypropylenes having desirable mechanical properties. The enhanced branching and improved crosslinking may lead to improved modulus, elasticity, melt strength, drawability (pull-off speed at break during measurement of melt strength), elongation, and other mechanical properties of the resulting branched polypropylenes.

Conventionally, phenolic stabilizers, such as Vitamin E or a Vitamin E derivative, are utilized to promote radical-mediated modification of a substantially linear polypropylene. However, it was discovered in the present disclosure, that the presence of phenolic stabilizers, such as Vitamin E or Vitamin E derivatives, may have an undesirable impact on MFR values. In addition, lower melt strength and undesirable yellowing of the branched polypropylenes may occur in some cases in the presence of Vitamin E and other phenolic stabilizers. As used herein “Vitamin E” refers to alpha-tocopherol, beta-tocopherol, gamma-tocopherol, delta-tocopherol, alpha-tocotrienol, beta-tocotrienol, gamma-tocotrienol, delta-tocotrienol, or any combination thereof. “Vitamin E derivatives” are produced directly from the foregoing compounds.

Accordingly, in any embodiment herein, a stabilizer may be omitted from the substantially linear polypropylenes when forming the branched polypropylenes, or, if a stabilizer needs to be present (e.g., to regulate excessive scissioning and ineffective branching), a non-phenolic stabilizer may be utilized. In another example, a non-phenolic stabilizer may be introduced to the branched polypropylene after the branched polypropylene has been formed from a substantially linear polypropylene lacking a stabilizer, such as while forming a foamable composition of the present disclosure. Thus, in any embodiment of the present disclosure, a non-phenolic stabilizer may be optionally present, either when forming a branched polypropylene and/or when formulating a branched polypropylene into a foamable composition. In some embodiments, the branched polypropylenes and/or the foamable compositions may be stabilizer-free. In still another example, a phenolic stabilizer may be introduced to a branched polypropylene after irradiation has been completed.

When used, suitable non-phenolic stabilizers may include but are not limited to quinolines, e.g., trimethylhydroxyquinoline (TMQ); imidazoles, e.g., zinc mercapto toluoyl imidazole (ZMTI); and conventional antioxidants, such as, lactone-based stabilizers, phosphates, phosphites, hindered amines, hydroxylamines, and combinations thereof. Commercial non-phenolic antioxidants may include, for example, IRGAFOS® 168, IRGAFOS® 126, IRGASTAB® 410, IRGASTAB® FS-042, and CHIMASSORB 944®. In one or more embodiments, the optional stabilizer may comprise a phosphite ester, such as tris-(2,4-di-tert-butylphenyl)phosphite.

When used, the non-phenolic stabilizer may be present in an amount of at least 0.1 wt %, based on total polymer mass within the branched polypropylene or foamable composition. In more specific examples, the non-phenolic stabilizer may be present in an amount of about 0.1 wt % to about 5 wt %, or about 0.1 wt %, about 0.15 wt % or about 0.2 wt % to about 1 wt %, or about 2.5 wt %, or about 5 wt %, based on total polymer mass within the branched polypropylene or foamable composition.

Branching by irradiation may be promoted with a crosslinking catalyst, such as organic bases, carboxylic acids, and organometallic compounds including organic titanates and complexes or carboxylates of lead, cobalt, iron, nickel, zinc, and tin (e.g., dibutyltindilaurate, dioctyltinmaleate, dibutyltindiacetate, dibutyltindioctanoate, stannous acetate, stannous octanoate, lead naphthenoate, zinc caprylate, cobalt naphthenoate, and the like). In the case where irradiation is accomplished via ultraviolet radiation, one or more UV sensitizers, which generate free radicals in the presence of UV radiation, may be employed to promote crosslinking. Such UV sensitizers are known in the art, and include compounds such as halogenated polynuclear ketones, carbonyl compounds such as dialkyl ketones, alkyl aryl phenones, benzophenones, and tricyclic fused ring compounds, and carbonylated phenol nuclear sulfonyl chlorides.

Irradiation with ionizing radiation may be carried out in a reduced oxygen environment (<15%) or a substantially oxygen-free environment and the branched polypropylene may be maintained in the environment for an extended period of time. The reduced oxygen environment may lead to a decrease in free radical content of the enclosed composition. Further description of a reduced oxygen environment can be found in U.S. Pat. No. 8,399,526, for example. An inert gas (e.g. nitrogen, helium, argon, or the like) may aid in maintaining a suitable reduced oxygen environment.

A variety of foaming agents, both physical and chemical, may be present in the foamable compositions of the present disclosure, which are capable of converting the foamable composition into a foamed form. The foaming agent may cause expansion of the branched polypropylene by foaming under specified conditions to produce the foamed form.

Chemical foaming agents undergo a reaction to produce a gas under specified foaming conditions. Chemical foaming agents may include azodicarbonamide, azodiisobutyronitrile, benzenesulfonhydrazide, azocyclohexylnitrile, azodiaminobenzene, barium azodicarboxylate, 4,4-oxybenzene sulfonylsemicarbazide, p-toluenesulfonyl semicarbazide, N,N′-dimethyl-N,N′-dinitrosoterephthalamide, N,N′-dinitrosopentamethylene tetramine, trihydrazino triazine, and azides (e.g., calcium azide). Other suitable chemical foaming agents include, but are not limited to, nitroso compounds, azo compounds, sulfonyl hydrazide compounds, such as benzenesulfonyl hydrazide, toluenesulfonyl hydrazide, p,p′-oxybis(benzene sulfonyl hydrazide), and diphenyl sulfone-3,3′-disulfonyl hydrazide; and azide compounds, such as 4,4′-diphenyl disulfonyl azide, and p-toluenesulfonyl azide.

Physical foaming agents undergo expansion upon changing from a higher-pressure state to a lower-pressure state, but without undergoing a chemical reaction in most cases. Physical foaming agents may include both organic foaming agents and inorganic foaming agents. Suitable organic foaming agents include, for example, aliphatic hydrocarbons having 1-9 carbon atoms (e.g., methane, ethane, propane, n-butane, isobutane, n-pentane, isopentane, neopentane, and the like), halogenated aliphatic hydrocarbons having 1-4 carbon atoms, aliphatic alcohols having 1-3 carbon atoms, and the like. Halogenated hydrocarbons may include such as chlorofluorocarbons, hydrochlorofluorocarbons, and preferably, fluorinated hydrocarbons. Examples of fluorinated hydrocarbons include methyl fluoride; perfluoromethane; ethyl fluoride; 1,1-difluoroethane (HFC-152a); 1,1,1-trifluoroethane (HFC-143a); 1,1,1,2-tetrafluoro-ethane (HFC-134a); pentafluoroethane; perfluoroethane; 2,2-difluoropropane; 1,1,1-trifluoropropane; perfluoropropane; perfluorobutane; and perfluorocyclobutane. Partially halogenated chlorocarbons and chlorofluorocarbons suitable for use as a foaming agent include methyl chloride; methylene chloride; ethyl chloride; 1,1,1-trichloroethane; 1,1-dichloro-1-fluoroethane (HCFC-141b); 1-chloro-1,1-difluoroethane (HCFC-142b); 1,1-dichloro-2,2,2-trifluoroethane (HCFC-123); and 1-chloro-1,2,2,2-tetrafluoroethane (HCFC-124). Fully halogenated chlorofluorocarbons include trichloromonofluoromethane (CFC-11); dichlorodifluoromethane (CFC-12); trichlorotrifluoroethane (CFC-113); dichlorotetrafluoroethane (CFC-114); chloroheptafluoropropane; and dichlorohexafluoropropane. Aliphatic alcohols useful as foaming agents include methanol, ethanol, n-propanol, and isopropanol.

Suitable inorganic foaming agents that are physical foaming agents may include carbon dioxide, nitrogen, argon, water, air, nitrogen, helium, and combinations thereof. Inorganic foaming agents that are chemical foaming agents also include sodium bicarbonate; sodium carbonate; ammonium bicarbonate; ammonium carbonate; and ammonium nitrite. Preferably, the foamable compositions may comprise nitrogen, carbon dioxide, n-butane, isobutane, n-pentane, isopentane, or any combination thereof in a suitable amount as a foaming agent.

The amount of foaming agent incorporated into the foamable compositions (typically a polymer melt) may be from about 0.01 wt % to about 10 wt %, based on total mass of the foamable composition, and preferably from about 0.1 wt % to about 5 wt %. The amount of foaming agent may be altered to obtain a desired foam density and/or cell size.

A foaming assistant may be used with the foaming agent. The simultaneous use of a foaming agent and a foaming assistant may contribute to lowering of the decomposition temperature of the foaming agent, acceleration of decomposition and homogenization of bubbles, or any combination thereof. Examples of suitable foaming assistants may include, for example, organic acids such as salicylic acid, phthalic acid, stearic acid and nitric acid, urea and derivatives thereof. The amount of foaming assistant incorporated into the foamable compositions (typically a polymer melt) may range from about 0.01 wt % to about 10 wt % and preferably from about 0.1 wt % to about 5 wt %, more preferably about 0.5 wt % to about 3 wt, %, based on total mass of the foamable compositions.

Additives may be included in the foamable compositions of the present disclosure. Suitable additives may include those commonly employed with plastics such as heat stabilizers, plasticizers, neutralizers, slip agents, antiblock agents, pigments, antifogging agents, antistatic agents, clarifiers, nucleating agents, ultraviolet absorbers or light stabilizers, fillers and other additives in conventional amounts. The feeding rate of a foaming agent and nucleating agent may be adjusted to achieve a relatively low density foam and small cell size, which results in a foam having thin cell walls. The foregoing additives may be introduced prior to or following the post-polymerization modification of the linear polypropylene during one or more compounding operations.

The foamable compositions and foamed products formed therefrom can be produced by a number of processes, such as compression molding, injection molding, and hybrids of extrusion and molding. The processes may comprise mixing the branched polypropylene under heat to form a melt, along with foaming agents and other typical additives, to produce a homogeneous or heterogeneous blend. The ingredients may be mixed and blended by any means known in the art, such as with a Banbury, intensive mixers, two-roll mill, and extruder. Time, temperature, and shear rate may be regulated to ensure optimum dispersion without premature foaming. An excessive temperature of mixing may result in premature foaming by decomposition of foaming agents or cell collapse due to lack of stabilization of the structure. When the melt temperature is too low, in contrast, foaming may be limited because the material solidifies before the cells have the possibility to expand fully. An adequate temperature is desired to promote adequate mixing of polymers and dispersion of other ingredients. The upper temperature limit for safe operation may depend on the onset decomposition temperatures of foaming agents employed. The decomposition temperature of some foaming agents is lower than the melt temperature of the polymer. In this case, the polymers may be melt blended before being compounded with other ingredient(s). The resultant mixture can be then compounded with the ingredients. Extruders with staged cooling/heating can be also employed. The latter part of the foam extruder is dedicated to the melt cooling and intimate mixing of the polymer-foaming agent system. After mixing, shaping can be carried out. Sheeting rolls or calendar rolls are often used to make appropriately dimensioned sheets for foaming. An extruder may be used to shape the composition into pellets. Foaming can be carried out in a compression mold at a temperature and time to complete the decomposition of foaming agents. Pressures, molding temperature, and heating time may be controlled. Foaming can also be carried out in injection molding equipment by using the foamable compositions in pellet form. The resulting foamed form can be further shaped to the dimension of finished products by any means known in the art, such as by thermoforming and compression molding. Further shaping of the foamed products after formation thereof may also be conducted in some cases, such as machining or polishing.

Depending on the type of foaming agent employed, a foamable composition produced by melt blending may be converted directly into a foamed product, or the foamable composition may be collected as a solid after the melt blend has cooled with the foaming agent incorporated therein. For example, when a physical foaming agent is utilized, the melt blend may be extruded with depressurization such that the foaming agent undergoes depressurization during extrusion to promote formation of the foamed product. A solidified polymer blend containing a chemical foaming agent, in contrast, may be collected and converted into a foamed form at a later time under suitable conditions that promote decomposition of the foaming agent to produce a gas. Alternately, however, a polymer blend containing a chemical foaming agent may too undergo direct conversion to a foamed product following extrusion of a melt blend.

Accordingly, polymer foaming processes of the present disclosure may comprise introducing a foaming agent into a branched polypropylene to form a foamable composition, and inducing foam formation within the foamable composition to produce a foamed product comprising a foamed form of the foamable composition. Introduction of the foaming agent may comprise a melt blending operation, for example, during which other optional components may also be introduced to the melt blend. Inducing foam formation of the foamable composition may comprise depressurizing the foamable composition, exposing the foamable composition to conditions that decompose the foaming agent, or any combination thereof to promote foaming. The polymer foaming processes may further comprise forming the branched polypropylene by irradiation, such as the e-beam irradiation processes discussed above. The foamable compositions may be free of a phenolic stabilizer and have a g′ᵥᵢₛ value of about 0.5 to about 0.95 or about 0.5 to about 0.9. Optionally, the foamable compositions and foamed products resulting in the polymer foaming processes may be stabilizer-free in some cases.

As a result of the above-described process, the foamed form of the foamable compositions described herein may have an expansion ratio of about 5 to about 45, or about 10 to about 40, or about 10 to about 30 within a temperature range of about 110 °C to about 180 °C or about 120 °C to about 150 °C. Batch foaming processes may tend to afford higher expansion ratios than do extrusion foaming processes utilizing the same foamble composition. The foamed form of the foamable compositions may have a maximum expansion ratio within a temperature range of about 110 °C to about 180 °C, or about 110 °C to about 170 °C, or about 120 °C to about 180 °C, or about 120 °C to about 150 °C, or about 120 °C to about 140 °C, or about 130 °C to about 160 °C. Expansion ratio can be measured by dividing the density of the foamed form by the density of the polypropylene from which it originates.

The foamed form may have an average cell diameter of about 10 μm to about 150 μm, or about 30 μm to about 120 μm, or about 50 μm to about 110 μm, or about 40 μm to about 100 μm, or about 50 μm to about 120 μm, as determined by ASTM D3576-04.

The foamed form may have an average cell density of about 10⁷ cells/cm³ to about 10⁸ cells/cm³. Foam density is determined according to ASTM D1622-08. The foamed form may have a bulk density of about 0.1 g/cm³.

Foamed products may comprise a foamed form having open cells, closed cells, or any combination thereof. The percentage of open or closed cells in a foamed product may be determined according to ASTM D2856-A.

Polyolefin foams are commonly made by extrusion processes that are well known in the art. Preferably, the extruders are longer than standard types, typically with an overall L/D (length to diameter) ratio of about 40 or greater, in either a single or tandem extruder configuration. In the case of the foamable compositions disclosed herein, the melt temperature within the extruder may range from about 130 °C to about 180 °C, preferably about 158 °C to about 174 °C. Batch foaming processes may also be suitably utilized in the disclosure herein.

It will be understood by persons having ordinary skill in the art that the steps outlined above may be varied, depending upon the desired result. For example, the foamable compositions of the present disclosure may be directly thermoformed or blow molded without an active cooling step. Other parameters may be varied as well in order to achieve foamed products having specified features.

The foamable compositions of the present disclosure have applications in sheet extrusion, in which foamed sheets may be subsequently thermoformed into packaging containers. In other applications, foamed products of the present disclosure may include a variety of molded parts, particularly molded parts related to and used in the automotive industry. Foamable compositions in which the branched polypropylene copolymers have a relatively high MFR value (e.g., about 10 dg/10 min or above, or about 20 dg/10 min or above, or about 40 dg/10 min or above) may be utilized in injection molding foaming processes in a non-limiting example.

### Additional Embodiments

Embodiments disclosed herein include:
A. Foamable compositions. The foamable compositions comprise: a branched polypropylene having a g′ᵥᵢₛ value of about 0.5 to about 0.95; and a foaming agent blended with the branched polypropylene; wherein the foamable composition is free of a phenolic stabilizer.
B. Foamed products comprising the foamable compositions of A converted to a foamed form.
C. Polymer foaming processes employing the foamable compositions of A. The processes comprise: introducing a foaming agent into a branched polypropylene having a g′ᵥᵢₛ value of about 0.5 to about 0.95 to form a foamable composition; wherein the foamable composition is free of a phenolic stabilizer; and inducing foam formation within the foamable composition to produce a foamed product comprising a foamed form of the foamable composition.
D. Foamable compositions containing a phenolic stabilizer. The foamable compositions comprise: a branched polypropylene having a g′ᵥᵢₛ value of about 0.5 to about 0.95; a foaming agent blended with the branched polypropylene; and a phenolic stabilizer; wherein the phenolic stabilizer is combined with the branched polypropylene after forming the branched polypropylene from a substantially linear polypropylene.
E. Foamed products comprising the foamable compositions of D converted to a foamed form.
F. Polymer foaming processes employing the foamable compositions of D. The processes comprise: providing a substantially linear polypropylene; converting the substantially linear polypropylene by irradiation with ionizing radiation into a branched polypropylene having a g′ᵥᵢₛ value of about 0.5 to about 0.95; wherein irradiation of the substantially linear polypropylene is conducted in absence of a phenolic stabilizer; and after irradiation is complete, blending a phenolic stabilizer with the branched polypropylene.

Embodiments A, B, C, D, E, and F may have one or more of the following elements present in any combination:
Element 1: wherein the branched polypropylene is produced by irradiation of a substantially linear polypropylene with ionizing radiation.
Element 2: wherein the branched polypropylene has an Mz/Mw of about 7 or less.
Element 3: wherein the branched polypropylene has an Mw/Mn of about 8 or less.
Element 4: wherein the branched polypropylene has a melt strength of about 25 cN or greater at 190 °C.
Element 5: wherein the branched polypropylene has a melt flow rate of about 0.1 dg/min to about 90 dg/min, as determined by ASTM1238-20 (2.16 kg at 230 °C).
Element 6: wherein the foaming agent comprises nitrogen, carbon dioxide, n-butane, isobutane, n-pentane, isopentane, or any combination thereof.
Element 7: wherein the foamable composition has an expansion ratio of about 10 to about 40 within a temperature range of about 120 °C to about 150 °C
Element 8: wherein the foamable composition has a maximum expansion ratio within a temperature range of about 110 °C to about 180 °C.

By way of non-limiting example, illustrative combinations applicable to A, B, C, D, E, and F may include, but are not limited to, 1 and 2; 1 and 3; 1, 2, and 4; 1, 3, and 4; 1, 2, 4, and 5; 1, 3, 4, and 5; 1, 2, 4, 5, and 6; 1, 3, 4, 5, and 6; 1, 4, and 6; 1, 5, and 6; 2 and 3; 2 and 4; 2 and 5; 2 and 6; 2 and 7; 2 and 8; 3 and 4; 3 and 5; 3 and 6; 3 and 7; 3 and 8; 4 and 5; 4 and 6; 4 and 7; 4 and 8; 5 and 6; 5 and 7; 5 and 8; 6 and 7; 6 and 8; and 7 and 8.

Embodiments A, B, and C may further have one or more of the following elements present in any combination:
Element 9: wherein the foamable composition is free of Vitamin E or a Vitamin E derivative.
Element 10: wherein the foamable composition further comprises a non-phenolic stabilizer.
Element 11: wherein irradiation of the branched polypropylene is conducted in an absence of stabilizer or in the presence of a non-phenolic stabilizer.

By way of non-limiting example, illustrative combinations applicable to A, B, and C may include any foregoing combinations applicable to A, B, C, D, E, and F, in further combination with 9, 10, and/or 11.

Embodiments B and E may further have one or more of the following elements present in any combination:
Element 12: wherein the foamed product has an average cell diameter of about 50 μm to about 110 μm.
Element 13: wherein the foamed product has an average cell density of about 10⁷ cells/cm³ to about 10⁸ cells/cm³.

By way of non-limiting example, illustrative combinations applicable to B and E may include any foregoing combinations applicable to A, B, C, D, E, and F, in further combination with 12 and/or 13.

Additional embodiments disclosed herein include:
Embodiment 1. A foamable composition comprising: a branched polypropylene having a g′ᵥᵢₛ value of about 0.5 to about 0.95; and a foaming agent blended with the branched polypropylene; wherein the foamable composition is free of a phenolic stabilizer.
Embodiment 2. The foamable composition of Embodiment 1, wherein the foamable composition is free of Vitamin E or a Vitamin E derivative.
Embodiment 3. The foamable composition of Embodiment 1 or Embodiment 2, further comprising: a non-phenolic stabilizer.
Embodiment 4. The foamable composition of any one of Embodiments 1 to 3, wherein the branched polypropylene is produced by irradiation of a substantially linear polypropylene with ionizing radiation.
Embodiment 5. The foamable composition of any one of Embodiments 1 to 4, wherein the branched polypropylene has an Mz/Mw of about 7 or less.
Embodiment 6. The foamable composition of any one of Embodiments 1 to 5, wherein the branched polypropylene has an Mw/Mn of about 8 or less.
Embodiment 7. The foamable composition of any one of Embodiments 1 to 6, wherein the branched polypropylene has a melt strength of about 25 cN or greater at 190 °C.
Embodiment 8. The foamable composition of any one of Embodiments 1 to 7, wherein the branched polypropylene has a melt flow rate of about 0.1 dg/min to about 90 dg/min, as determined by ASTM1238-20 (2.16 kg at 230 °C).
Embodiment 9. The foamable composition of any one of Embodiments 1 to 8, wherein the foaming agent comprises nitrogen, carbon dioxide, n-butane, isobutane, n-pentane, isopentane, or any combination thereof.
Embodiment 10. A foamed product comprising the foamable composition of any one of Embodiments 1 to 9 converted to a foamed form.
Embodiment 11. The foamed product of Embodiment 10, wherein the foamable composition has an expansion ratio of about 10 to about 40 within a temperature range of about 120 °C to about 150 °C.
Embodiment 12. The foamed product of Embodiment 10 or Embodiment 11, wherein the foamable composition has a maximum expansion ratio within a temperature range of about 110 °C to about 180 °C.
Embodiment 13. The foamed product of any one of Embodiments 10 to 12, wherein the foamed product has an average cell diameter of about 50 μm to about 110 μm.
Embodiment 14. The foamed product of any one of Embodiments 10 to 13, wherein the foamed product has an average cell density of about 10⁷ cells/cm³ to about 10⁸ cells/cm³.
Embodiment 15. A polymer foaming process comprising: introducing a foaming agent into a branched polypropylene having a g′ᵥᵢₛ value of about 0.5 to about 0.95 to form a foamable composition; wherein the foamable composition is free of a phenolic stabilizer; and inducing foam formation within the foamable composition to produce a foamed product comprising a foamed form of the foamable composition.
Embodiment 16. The polymer foaming process of Embodiment 15, wherein the foamable composition is free of Vitamin E or a Vitamin E derivative.
Embodiment 17. The polymer foaming process of Embodiment 15 or Embodiment 16, further comprising: a non-phenolic stabilizer.
Embodiment 18. The polymer foaming process of any one of Embodiments 15 to 17, wherein the branched polypropylene is produced by irradiation of a substantially linear polypropylene with ionizing radiation.
Embodiment 19. The polymer foaming process of any one of Embodiments 15 to 18, wherein irradiation of the branched polypropylene is conducted in an absence of stabilizer or in the presence of a non-phenolic stabilizer.
Embodiment 20. The polymer foaming process of any one of Embodiments 15 to 19, wherein the branched polypropylene has an Mz/Mw of about 7 or less.
Embodiment 21. The polymer foaming process of any one of Embodiments 15 to 20, wherein the branched polypropylene has an Mw/Mn of about 8 or less.
Embodiment 22. The polymer foaming process of any one of Embodiments 15 to 21, wherein the branched polypropylene has a melt flow rate of about 0.1 dg/min to about 90 dg/min, as determined by ASTM1238-20 (2.16 kg at 230 °C).
Embodiment 23. The polymer foaming process of any one of Embodiments 15 to 22, wherein the foaming agent comprises nitrogen, carbon dioxide, n-butane, isobutane, n-pentane, isopentane, or any combination thereof.
Embodiment 24. The polymer foaming process of any one of Embodiments 15 to 23, wherein the foamed product has an average cell diameter of about 50 μm to about 110 μm.
Embodiment 25. The polymer foaming process of any one of Embodiments 15 to 24, wherein the foamed product has an average cell density of about 10⁷ cells/cm³ to about 10⁸ cells/cm³.
Embodiment 26. A foamable composition comprising: a branched polypropylene having a g′ᵥᵢₛ value of about 0.5 to about 0.95; a foaming agent blended with the branched polypropylene; and a phenolic stabilizer; wherein the phenolic stabilizer is combined with the branched polypropylene after forming the branched polypropylene from a substantially linear polypropylene.
Embodiment 27. A method comprising: providing a substantially linear polypropylene; converting the substantially linear polypropylene by irradiation into a branched polypropylene having a g′ᵥᵢₛ value of about 0.5 to about 0.95; wherein irradiation of the substantially linear polypropylene is conducted in absence of a phenolic stabilizer; and after irradiation is complete, blending a phenolic stabilizer with the branched polypropylene.

To facilitate a better understanding of the embodiments of the present disclosure, the following examples of preferred or representative embodiments are given. In no way should the following examples be read to limit, or to define, the scope of the invention.

### Examples

### Linear Polypropylenes.

Linear polypropylenes were obtained from commercial sources or synthesized in house and were either irradiated as received/synthesized or blended with a stabilizer (see Table 1 for formulations). Characterization data for selected linear polypropylenes is provided in Table 3 below.

### E-Beam Modification Process.

The linear polypropylenes above were converted to branched polypropylenes by e-beam irradiation. The e-beam irradiation was conducted upon the linear polypropylenes by a commercial vendor.

### Polymer Characterization.

Unless otherwise indicated, the distribution and the moments of molecular weight (Mw, Mn, Mz, Mw/Mn, etc.), the comonomer content, and the branching index (g′ᵥᵢₛ) were determined by using a high temperature Gel Permeation Chromatography (Polymer Char GPC-IR) equipped with a multiple-channel band-filter based Infrared detector IR5 with a multiple-channel band filter based infrared detector ensemble IR5 with band region covering from about 2,700 cm⁻¹ to about 3,000 cm⁻¹ (representing saturated C—H stretching vibration), an 18-angle light scattering detector and a viscometer. Three Agilent PLgel 10-mm Mixed-B LS columns were used to provide polymer separation. Reagent grade 1,2,4-trichlorobenzene (TCB) (from Sigma-Aldrich) comprising ~300 ppm antioxidant BHT was used as the mobile phase at a nominal flow rate of ~1.0 mL/min and a nominal injection volume of ~200 mL. The whole system including transfer lines, columns, and detectors was contained in an oven maintained at ~145 °C. A given amount of sample was weighed and sealed in a standard vial with −10 mL flow marker (heptane) added thereto. After loading the vial in the auto-sampler, the oligomer or polymer may automatically be dissolved in the instrument with ~8 mL added TCB solvent at ~160 °C with continuous shaking. The sample solution concentration was from ~0.2 to ~2.0 mg/ml, with lower concentrations being used for higher molecular weight samples. The concentration, c, at each point in the chromatogram was calculated from the baseline-subtracted IR5 broadband signal, l, using the equation: c=al, where a is the mass constant determined with polyethylene or polypropylene standards. The mass recovery was calculated from the ratio of the integrated area of the concentration chromatography over elution volume and the injection mass which is equal to the pre-determined concentration multiplied by injection loop volume. The conventional molecular weight (IR MW) was determined by combining universal calibration relationship with the column calibration which is performed with a series of monodispersed polystyrene (PS) standards ranging from 700 to 10M gm/mole. The MW at each elution volume was calculated with Equation 1:

$$log M = \frac{log {K}_{PS} / K}{α + 1} + \frac{{α}_{ps} + 1}{α + 1} log {M}_{PS} \qquad Equation 1$$

where the variables with subscript “PS” stand for polystyrene while those without a subscript are for the test samples. In this method, α_{PS}=0.67 and K_{PS}=0.000175, α and K for other materials are as calculated as described in the published literature (e.g., Sun, T. et al. (2001) Macromolecules, v. 34, pg. 6812), except that for purposes of the present disclosure and claims thereto, α=0.705 and K=0.0000229 for ethylene-propylene copolymers and ethylene-propylene-diene terpolymers, α=0.695 and K=0.000579 for linear ethylene polymers, α=0.705 and K=0.0002288 for linear propylene polymers, and α=0.695 and K=0.000181 for linear butane polymers. Concentrations are expressed in g/cm³, molecular weight is expressed in g/mole, and intrinsic viscosity (hence K in the Mark-Houwink equation) is expressed in dL/g unless otherwise noted.

The comonomer composition was determined by the ratio of the IR5 detector intensity corresponding to CH₂ and CH₃ channel calibrated with a series of PE and PP homo/copolymer standards whose nominal values are predetermined by NMR or FTIR. In particular, this provides the methyls per 1,000 total carbons (CH₃/1000TC) as a function of molecular weight. The short-chain branch (SCB) content per 1,000TC (SCB/1000TC) is then computed as a function of molecular weight by applying a chain-end correction to the CH₃/1000TC function, assuming each chain to be linear and terminated by a methyl group at each end. The weight % comonomer is then obtained from the Equation 2 in which f is 0.3, 0.4, 0.6, 0.8, and so on for C₃, C₄, C₆, C₈, and so on co-monomers, respectively:

w2=f×SCB/1000TC Equation 2

The bulk composition of the polymer from the GPC-IR and GPC-4D analyses was obtained by considering the entire signals of the CH₃ and CH₂ channels between the integration limits of the concentration chromatogram. First, the following ratio in Equation 3 is obtained

$$Bulk IR ratio = \frac{Area of {CH}_{3} signal within integration limits}{Area of {CH}_{2} signal within integration limits} . \qquad Equation 3$$

Then the same calibration of the CH₃ and CH₂ signal ratio, as mentioned previously in obtaining the CH₃/1000TC as a function of molecular weight, is applied to obtain the bulk CH₃/1000TC. A bulk methyl chain ends per 1000 total carbons (bulk CH₃end/1000TC) is obtained by weight averaging the chain-end correction over the molecular weight range, as shown in Equations 4 and 5.

w2b=f×bulk CH₃/1000TC Equation 4

bulk SCB/1000TC=bulk CH₃/1000TC−bulk CH₃end/1000TC Equation 5

Bulk SCB/1000TC is then converted to bulk w2 in the same manner as described above.

The LS detector is the 18-angle Wyatt Technology High Temperature DAWN HELEOSII. The LS molecular weight (M) at each point in the chromatogram is determined by analyzing the LS output using the Zimm model for static light scattering (Light Scattering from Polymer Solutions; Huglin, M. B., Ed.; Academic Press, 1972.) using Equation 6:

$$\frac{{K}_{o} c}{Δ R ( θ )} = \frac{1}{MP ( θ )} + 2 {A}_{2} c . \qquad Equation 6$$

Here, ΔR(θ) is the measured excess Rayleigh scattering intensity at scattering angle θ, c is the polymer concentration determined from the IR5 analysis, A₂ is the second virial coefficient, P(θ) is the form factor for a monodisperse random coil, and Ko is the optical constant for the system, as in Equation 7:

$${K}_{o} = \frac{4 {π}^{2} {{n}^{2} ( dn / dc )}^{2}}{{λ}^{4} {N}_{A}} \qquad Equation 7$$

where N_{A} is Avogadro's number, and (dn/dc) is the refractive index increment for the system. The refractive index, n, is 1.500 for TCB at 145 °C and λ=665 nm. For analyzing polyethylene homopolymers, ethylene-hexene copolymers, and ethylene-octene copolymers, dn/dc=0.1048 ml/mg and A₂=0.0015; for analyzing ethylene-butene copolymers, dn/dc=0.1048*(1−0.00126*w2) ml/mg and A₂=0.0015 where w2 is weight percent butene comonomer.

A high temperature Agilent (or Viscotek Corporation) viscometer, which has four capillaries arranged in a Wheatstone bridge configuration with two pressure transducers, was used to determine specific viscosity. One transducer measures the total pressure drop across the detector, and the other, positioned between the two sides of the bridge, measures a differential pressure. The specific viscosity, ηₛ, for the solution flowing through the viscometer is calculated from their outputs. The intrinsic viscosity, [η], at each point in the chromatogram is calculated from the equation [η]=ηₛ/c, where c is concentration and is determined from the IRS broadband channel output. The viscosity MW at each point is calculated using Equation 8

M=K_{PS}M^{α}^{_{PS}}⁺¹/[η], Equation 8

where α_{PS} is 0.67 and K_{PS} is 0.000175.

The branching index (g′ᵥᵢₛ) was calculated using the output of the GPC-IRS-LS-VIS method as follows. The average intrinsic viscosity, [η]_{avg}, of the sample is calculated by Equation 9:

$${[ η ]}_{avg} = \frac{\sum {{c}_{i} [ η ]}_{i}}{\sum {c}_{i}} \qquad Equation 9$$

where the summations are over the chromatographic slices, i, between the integration limits. The branching index g′ᵥᵢₛ is defined in Equation 10:

$${g}_{v i s}^{′} = \frac{{[ η ]}_{avg}}{{KM}_{v}^{α}} , \qquad Equation 10$$

where M_{V} is the viscosity-average molecular weight based on molecular weights determined by LS analysis and the K and α are for the reference linear polymer, which are, for purposes of the present disclosure and claims thereto, α=0.705 and K=0.0000229 for ethylene-propylene copolymers and ethylene-propylene-diene terpolymers, α=0.695 and K=0.000579 for linear ethylene polymers, α=0.705 and K=0.000228 for linear propylene polymers, α=0.695 and K=0.000181 for linear butene polymers. Concentrations are expressed in g/cm³, molecular weight is expressed in g/mole, and intrinsic viscosity (hence K in the Mark-Houwink equation) is expressed in dL/g unless otherwise noted. Calculation of the w2b values is as discussed above.

Experimental and analysis details not described above, including how the detectors are calibrated and how to calculate the composition dependence of Mark-Houwink parameters and the second-virial coefficient, are further described by T. Sun, P. Brant, R. R. Chance, and W. W. Graessley (Macromolecules, 2001, Vol. 34 (19), pp. 6812-6820.

### Other Physical Properties.

Tm and Tc were determined using Differential Scanning calorimetry (DSC) according to ASTM D3418-03. DSC data was obtained using a TA Instruments model Q200 machine. Samples weighing approximately 5-10 mg were sealed in an aluminum hermetic sample pan. The DSC data were recorded by first gradually heating the sample to 200 °C at a rate of 10 °C/minute. The sample was kept at 200 °C for 2 minutes, cooled to −90 °C at a rate of 10 °C/minute, followed by an isothermal hold for 2 minutes, and finally heating to 200 °C at 10 °C/minute. Both the first and second cycle thermal events were recorded. Areas under the endothermic peaks were measured and used to determine the heat of fusion and the percent of crystallinity. The percent crystallinity was calculated using the formula, [area under the melting peak (Joules/gram)/B (Joules/gram)]*100, where B is the heat of fusion for the 100% crystalline homopolymer of the major monomer component. These values for B are obtained from the Polymer Handbook, Fourth Edition, published by John Wiley and Sons, New York 1999, provided; however, a value of 290 J/g is used for the heat of fusion for 100% crystalline polyethylene. The crystallization temperatures and melting temperatures reported here were obtained during the second heating/cooling cycle unless otherwise noted.

Tables 1 and 2 summarize physical properties of branched polypropylenes produced in accordance with the procedures above (post-irradiation). Table 3 below shows corresponding physical properties for the linear polypropylenes (pre-irradiation) used to produce the branched polypropylenes of Entries 7-10 below.

TABLE 1

| | | Melt | | | | | | |
|---|---|---|---|---|---|---|---|---|
| | | flow rate | | | | | | |
| | | (2.16 kg, | | | | | | |
| | Stabilizer | 230 °C) | Mn | Mw | Mz | | | |
| Entry | (wt %) | [dg/min] | [g/mol] | [g/mol] | [g/mol] | Mw/Mn | Mz/Mw | g′ᵥᵢₛ |
| 1 | 0 | 16.5 | 60,381 | 481,574 | 2,611,517 | 8.0 | 5.4 | 0.67 |
| 2 | 0.4^{a} | 21 | 57,887 | 247,647 | 743,225 | 4.3 | 3.0 | 0.87 |
| 3 | 0.2^{b} | 63 | 57,417 | 259,930 | 1,111,997 | 4.5 | 4.3 | 0.76 |
| 4 | 0.1^{c} | 2.7 | 25,771 | 179,880 | 1,003,111 | 6.9 | 5.6 | 0.81 |
| 5 | 0.1^{c} | 2.7 | 59,785 | 373,915 | 1,777,931 | 6.3 | 4.8 | 0.73 |
| 6 | 0.1^{c} | 4.2 | 88,370 | 366,661 | 1,347,389 | 4.1 | 3.7 | 0.80 |
| 7 | 0 | 9.2 | 71,179 | 590,099 | 3,089,849 | 8.3 | 5.2 | 0.59 |
| 8 | 0 | 1.6 | 81,405 | 519,732 | 2,440,305 | 6.4 | 4.7 | 0.69 |
| 9 | 0 | 1.2 | 60,102 | 410,676 | 2,234,915 | 6.8 | 5.4 | 0.65 |
| 10 | 0 | 4.9 | 50,854 | 395,635 | 2,146,208 | 7.8 | 5.4 | 0.67 |

^{a}0.4 wt % total stabilizers includes IRGANOX-3114 (phenolic antioxidant, BASF), IRGAFOS-168 (phosphite antioxidant, BASF), Vitamin E, and calcium stearate.
^{b}0.2 wt % total stabilizers includes IRGANOX-3114 (phenolic antioxidant, BASF), IRGAFOS-168 (phosphite antioxidant, BASF), and calcium stearate.
^{c}0.1 wt % total stabilizers includes 500 ppm IRGANOX-1010 (phenolic antioxidant, BASF) and 500 ppm IRGAFOS-168 (phosphite antioxidant, BASF).

TABLE 2

| | | | | | | 1% |
|---|---|---|---|---|---|---|
| | | | | | | Secant |
| | | Melt | Drawability | Peak | Peak | Flexural |
| | Stabilizer | Strength | at 190 °C | T_{c} | Tₘ | Modulus |
| Entry | (wt %) | (cN) | (mm/s) | (°C) | (°C) | (MPa) |
| 1 | 0 | 59.7 | 97.6 | 109.2 | ~155 | 1627 |
| 4 | 0.1 | 6 | 27 | N/D | N/D | N/D |
| 5 | 0.1 | 30 | 37 | N/D | N/D | N/D |
| 6 | 0.1 | 24 | 32 | N/D | N/D | N/D |
| 7 | 0 | 72 | 93 | 114 | 156 | 1821 |
| 8 | 0 | 62 | 77 | 109 | 147 | 1218 |
| 9 | 0 | 48 | 81 | 113 | 145 | 1175 |
| 10 | 0 | 41 | 89 | 113 | 159 | 1289 |

In Tables 1 and 2, the branched polypropylenes of Entries 1, 2, 3, and 7 are polypropylene homopolymers. The branched polypropylenes of Entries 4 and 5 are impact copolymers having a C₂ content of ~30-40% by weight of the elastomeric component. The branched polypropylene of Entry 6 is a random copolymer of ethylene (3 wt %) and propylene (97%). The branched polypropylene of Entry 8 is a random copolymer of ethylene (2 wt %) and propylene (98%). The branched polypropylenes of Entries 9 and 10 are impact copolymers containing a blend of polypropylene homopolymer (82 wt %) and elastomer (18 wt %). The elastomer was a ~1:1 wt/wt ethylene/propylene rubber.

TABLE 3

| Linear | | | | | | | |
|---|---|---|---|---|---|---|---|
| Polypropylene | | | | | | | |
| Precursor | Stabilizer | Mn | Mw | Mz | | | |
| to Entry # | (wt %) | (g/mol) | (g/mol) | (g/mol) | Mw/Mn | Mz/Mw | g′ᵥᵢₛ |
| 7 | 0 | 116,900 | 561,400 | 1,449,900 | 4.8 | 2.6 | 1.0 |
| 8 | 0 | 117,300 | 395,100 | 789,400 | 3.4 | 2.0 | 1.0 |
| 9 | 0 | 104,200 | 367,700 | 774,400 | 3.5 | 2.1 | 1.0 |
| 10 | 0 | 78,900 | 392,200 | 990,700 | 5.0 | 2.5 | 1.0 |

| | Melt | | | | 1% |
|---|---|---|---|---|---|
| Linear | flow rate | | | | Secant |
| Polypropylene | (2.16 kg, | Melt | Peak | Peak | Flexural |
| Precursor | 230 °C) | Strength | T_{c} | Tₘ | Modulus |
| to Entry # | [dg/min] | (cN) | (°C) | (°C) | (MPa) |
| 7 | 1.2 | 9.8 | 117 | 163 | 1409 |
| 8 | 1.7 | 6.8 | 107 | 150 | 924 |
| 9 | 2.2 | 11 | 115 | 163.6 | 837 |
| 10 | 2.5 | 7.2 | 116 | 164 | 946 |

Small amplitude oscillatory shear (SAOS) data were collected using an Advanced Rheometrics Expansion System (ARES-G2) from TA Instruments using parallel plates (diameter=25 mm) in a dynamic mode under circulating nitrogen atmosphere. For all experiments, the rheometer was thermally stabilized at 190 °C for at least 30 minutes before inserting a compression-molded sample onto the parallel plates. To determine the sample's viscoelastic behavior, frequency sweeps in the range from 0.01 to 628 rad/s were carried out at a temperature of 190 °C under constant strain. Depending on the molecular weight and temperature, strains in the linear deformation range verified by strain sweep test were used. A sinusoidal shear strain was applied to the sample if the strain amplitude was sufficiently small that the sample behaved linearly. It can be shown that the resulting steady-state stress will also oscillate sinusoidally at the same frequency but will be shifted by a phase angle δ with respect to the strain wave. The stress leads the strain by δ. For purely elastic materials δ=0° (stress is in phase with strain) and for purely viscous materials, δ=90° (stress leads the strain by 90° although the stress is in phase with the strain rate). For viscoelastic materials, 0<δ<90.

Rheological properties of the branched polypropylenes were fit to a Winter-Chambon model using Equation 11, wherein the rheological profile may characterize gel-like behavior, and

η″(ω)=SΓ(1−n)ωⁿ⁻¹ Equation 11

wherein η* represents the complex viscosity (Pa·s), ω represents the frequency, Γ is the Gamma function, S is the gel stiffness, and n is the critical network relaxation exponent. Based on the rheological profile, the polypropylenes may be characterized as having “gel-like” behavior (Table 4). Comparative data for selected linear polypropylenes is also given in Table 4.

TABLE 4

| | Linear Polypropylenes | | | | Branched Polypropylenes | | | |
|---|---|---|---|---|---|---|---|---|
| | | Critical | Tan | | | Critical | Tan | |
| | Gel | network | delta | | Gel | network | delta | |
| | stiffness, | relaxation | at | | stiffness, | relaxation | at | |
| Entry | S [Pa · sⁿ] | exponent, n | 0.01 rad/s | $\frac{{η}_{0.01 rad / s}}{{η}_{100 rad / s}}$ | S [Pa · sⁿ] | exponent, n | 0.01 rad/s | $\frac{{η}_{0.01 rad / s}}{{η}_{100 rad / s}}$ |
| 1 | — | — | — | — | 547 | 0.72 | 4.3 | 20.7 |
| 2 | — | — | — | — | 259 | 0.81 | 18 | 8.4 |
| 3 | — | — | — | — | 66 | 0.86 | 28 | 4.3 |
| 4 | — | — | — | — | 4270 | 0.17 | 0.3 | 508.9 |
| 5 | — | — | — | — | 2215 | 0.49 | 1.1 | 96.1 |
| 6 | — | — | — | — | 1074 | 0.69 | 3.8 | 25.5 |
| 7 | 1316 | 0.8 | 17.6 | 11.7 | 846 | 0.69 | 3.2 | 31.1 |
| 8 | 1160 | 0.8 | 31.1 | 10.0 | 971 | 0.62 | 2.8 | 41.7 |
| 9 | 1152 | 0.8 | 12.8 | 11.0 | 1077 | 0.58 | 1.5 | 51.0 |
| 10 | 1155 | 0.8 | 6.66 | 13.6 | 810 | 0.60 | 1.6 | 40.2 |

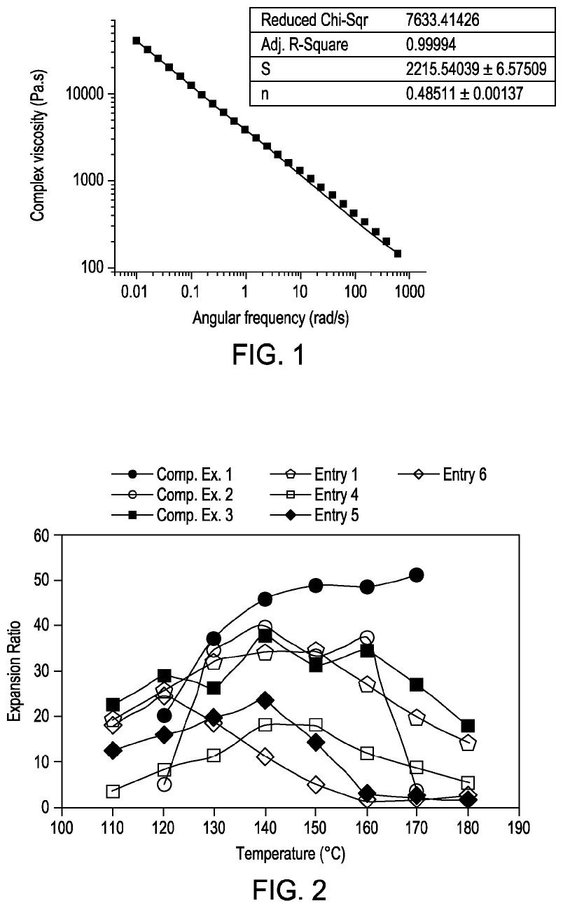

FIG. 1 is a graph of the small amplitude oscillatory shear (SAOS) data for the branched polypropylene of Entry 5 fit to the Winter-Chambon model.

### Batch Foaming Process.

The foaming apparatus used herein consisted of a chamber in which the temperature was accurately controlled by a band heater with proportional-integral-derivative feedback control. A CO₂ gas cylinder was connected to the chamber through a pipeline, and a syringe pump was used to supply a metered stream of gas to maintain the internal CO₂ pressure at a constant 2000 psi. After preheating the chamber to 210 °C, about 1 gram or less of the branched polypropylene was loaded and sealed in the chamber. CO₂ was injected into the chamber to saturate the branched polypropylene at 210 °C for a period of time dependent on the designated foaming temperature. Following CO₂ saturation, the heat supply was powered off, and the chamber was allowed to cool at a constant rate of 5.5 °C/min until the designated foaming temperature was reached. The chamber was rapidly depressurized and quenched after a total of 18 minutes of CO₂ saturation and cooling. Expansion ratio data was collected over a range of foaming temperatures.

FIG. 2 is a plot of expansion ratio as a function of temperature for branched polypropylenes in comparison to various commercial polypropylenes. As shown, the branched polypropylenes demonstrated ready foamability over a range of temperatures. The data in FIG. 2 was obtained under batch foaming conditions.

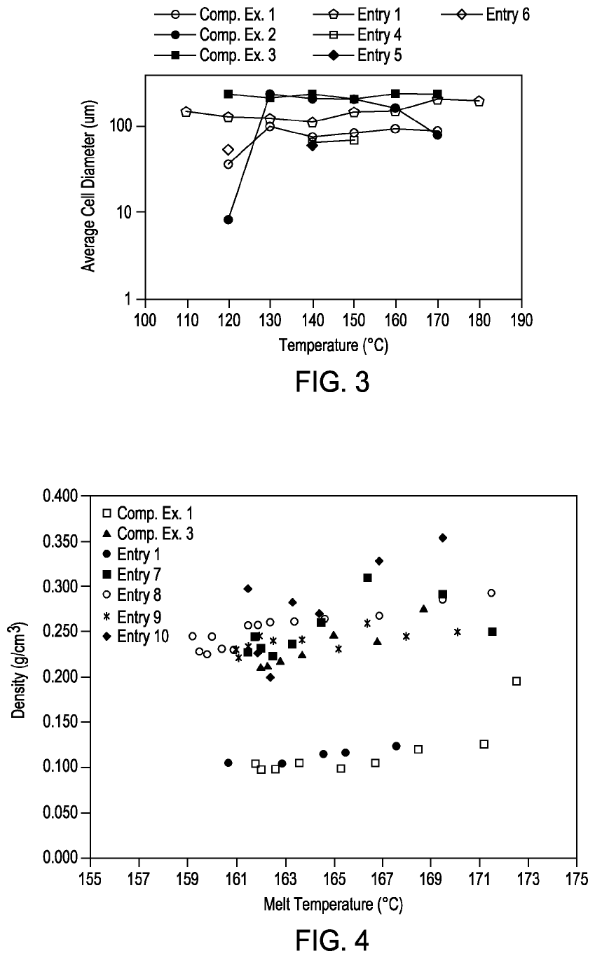

Cell morphology data of the foamed polypropylenes was collected via Scanning Electron Microscopy (SEM) in order to determine cell diameter and other related properties. FIG. 3 is a plot of average cell diameter as a function of temperature for foamed polypropylenes in comparison to various commercial polypropylenes. The data in FIG. 3 was obtained under batch foaming conditions.

FIG. 6 is a plot of cell density as a function of temperature for foamed polypropylenes in comparison to various commercial polypropylenes. The data in FIG. 6 was obtained under batch foaming conditions. As shown, the foamed polypropylenes resulting from irradiation and batch foaming demonstrated a range of cell density values that were similar to those of the commercial polypropylenes.

### Extrusion Foaming Process.

A tandem extrusion system, consisting of a 34 mm diameter co-rotating twin screw extruder (mixing extruder) feeding a 40 mm diameter single screw extruder (cooling extruder), was used for the production of the foam samples. Polymer pellets (dry coated with nucleating agent) were fed into the hopper of the twin-screw extruder through a solid metering feeder. All polypropylenes used were dry mixed with 0.75% talc (Mistron Vapor R). The blowing agent (CO₂) was injected in the twin-screw extruder through a dual-syringe pumping system (series 500D from Teledyne Company) at 20 length-to-diameter point of the extruder, after a complete melting of the material was achieved. The resin and CO₂ flow rates (i.e., 1.4% CO₂ content) and the screw speeds for the mixing and cooling extruders were kept constant in order to compare processing windows for foaming. The screws of the twin-screw extruder were specially configured to ensure good mixing of polymer and blowing agent. The barrel and the die temperatures of the single screw (cooling) extruder were controlled using three separate oil heaters to achieve proper cooling and temperature control. A rod die consisting of two holes with 1.27 mm diameters was attached at the end of the cooling extruder. The melt temperature was measured via a temperature probe in the melt behind the die.

FIG. 4 is a plot of foam density as a function of temperature for foamed polypropylenes in comparison to various commercial polypropylenes. The data in FIG. 4 was obtained under extrusion foaming conditions. As shown, the foam density was relatively constant over a range of melt temperatures.

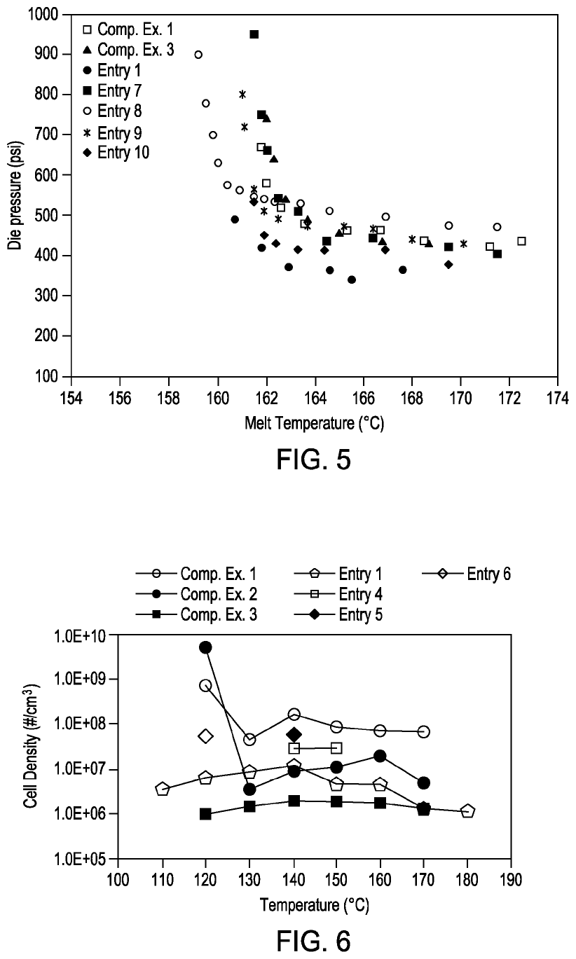

FIG. 5 is a plot of die pressure as a function of melt temperature during extrusion foaming. As shown, the die pressure decreased with increased melt temperature.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.”

Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by one or more embodiments described herein. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

1.-29. (canceled)

30. A foamable composition comprising:
a branched polypropylene having a g′ᵥᵢₛ value of about 0.5 to about 0.95; and
a foaming agent blended with the branched polypropylene;
wherein the foamable composition is free of a phenolic stabilizer.

31. The foamable composition of claim 1, wherein the foamable composition is free of Vitamin E or a Vitamin E derivative and wherein the foamable composition further comprises a non-phenolic stabilizer.

32. The foamable composition of claim 1, wherein the branched polypropylene is produced by irradiation of a substantially linear polypropylene with ionizing radiation.

33. The foamable composition of claim 1, wherein the branched polypropylene has:
(a) an Mz/Mw of about 7 or less,
(b) an Mw/Mn of about 8 or less,
(c) a melt strength of about 25 cN or greater at 190 °C,
(d) a melt flow rate of about 0.1 dg/min to about 90 dg/min, as determined by ASTM1238-20 (2.16 kg at 230 °C), or
(e) any combination of (a), (b), (c), and (d).

34. The foamable composition of claim 1, wherein the foaming agent comprises nitrogen, carbon dioxide, n-butane, isobutane, n-pentane, isopentane, or any combination thereof.

35. A foamed product comprising the foamable composition of claim 1 converted to a foamed form.

36. The foamed product of claim 35, wherein the branched polypropylene has a melt flow rate of about 0.1 dg/min to about 90 dg/min, as determined by ASTM1238-20 (2.16 kg at 230 °C).

37. The foamed product of claim 35, wherein the foaming agent comprises nitrogen, carbon dioxide, n-butane, isobutane, n-pentane, isopentane, or any combination thereof.

38. The foamed product of claim 35, wherein the foamable composition has an expansion ratio of about 10 to about 40 within a temperature range of about 120 °C to about 150 °C.

39. The foamed product of claim 35, wherein the foamable composition has a maximum expansion ratio within a temperature range of about 110 °C to about 180 °C.

40. The foamed product of claim 35, wherein the foamed product has an average cell diameter of about 50 μm to about 110 μm and an average cell density of about 10⁷ cells/cm³ to about 10⁸ cells/cm³.

41. A polymer foaming process comprising:
introducing a foaming agent into a branched polypropylene having a g′ᵥᵢₛ value of about 0.5 to about 0.95 to form a foamable composition;
wherein the foamable composition is free of a phenolic stabilizer; and
inducing foam formation within the foamable composition to produce a foamed product comprising a foamed form of the foamable composition.

42. The polymer foaming process of claim 41, wherein the foamable composition is free of Vitamin E or a Vitamin E derivative and wherein the foamable composition further comprises a non-phenolic stabilizer.

43. The polymer foaming process of claim 41, wherein the foamed product has an average cell density of about 10⁷ cells/cm³ to about 10⁸ cells/cm³.

44. The polymer foaming process of claim 41, wherein the branched polypropylene is produced by irradiation of a substantially linear polypropylene with ionizing radiation.

45. The polymer foaming process of claim 44, wherein irradiation of the branched polypropylene is conducted in an absence of stabilizer or in the presence of a non-phenolic stabilizer.

46. The polymer foaming process of claim 41, wherein the branched polypropylene has
(a) an Mz/Mw of about 7 or less,
(b) an Mw/Mn of about 8 or less,
(c) a melt strength of about 25 cN or greater at 190 °C,
(d) a melt flow rate of about 0.1 dg/min to about 90 dg/min, as determined by ASTM1238-20 (2.16 kg at 230 °C), or
(e) any combination of (a), (b), (c), and (d).

47. The polymer foaming process of claim 41, wherein the foaming agent comprises nitrogen, carbon dioxide, n-butane, isobutane, n-pentane, isopentane, or any combination thereof.

48. The polymer foaming process of claim 41, wherein the foamed product has an average cell diameter of about 50 μm to about 110 μm.

49. A foamable composition comprising:
a branched polypropylene having a g′ᵥᵢₛ value of about 0.5 to about 0.95;
a foaming agent blended with the branched polypropylene; and
a phenolic stabilizer;
wherein the phenolic stabilizer is combined with the branched polypropylene after forming the branched polypropylene from a substantially linear polypropylene.

50. A method comprising:
providing a substantially linear polypropylene;
converting the substantially linear polypropylene by irradiation with ionizing radiation into a branched polypropylene having a g′ᵥᵢₛ value of about 0.5 to about 0.95;
wherein irradiation of the substantially linear polypropylene is conducted in absence of a phenolic stabilizer; and
after irradiation is complete, blending a phenolic stabilizer with the branched polypropylene.
